(19) United States
(12) Patent Application Publication
(10) Pub. No.: US 2025/0392114 A1
(43) Pub. Date: Dec. 25, 2025

(54) IN-VEHICLE CUTOFF CONTROL DEVICE

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Takahiro KURATOMI, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/879,753

(22) PCT Filed: Jun. 30, 2022
(86) PCT No.: PCT/JP2022/026240

§ 371 Date: Dec. 28, 2024

(51) Int. Cl. H02H 3/38; B60L 58/20; H02H 7/18

(52) U.S. Cl. CPC H02H 3/38; B60L 58/20; H02H 7/18

(57) ABSTRACT

An in-vehicle cutoff control device includes a conductive path, a voltage generation unit, a short-circuit detection unit, and a drive unit. The conductive path is insulated from the low-voltage battery. The voltage generation unit generates a voltage to be applied to the conductive path, based on an output voltage of a low-voltage battery or a high-voltage battery. The short-circuit detection unit is driven by power received from the conductive path. The drive unit is operated by power received from the conductive path and outputs a cutoff signal for switching the cutoff unit to a cutoff state. The short-circuit detection unit receives input of a detection signal and detects a short-circuit of the power path based on the detection signal. The drive unit switches the cutoff unit to the cutoff state if the short-circuit detection unit has detected a short-circuit of the power path.

### CROSS-REFERENCE TO RELATED APPLICATIONS

This application is the U.S. national stage of PCT/JP2022/026240 filed on Jun. 30, 2022, the contents of which are incorporated herein.

### TECHNICAL FIELD

The present disclosure relates to an in-vehicle cutoff control device.

### BACKGROUND

JP S62-21322A discloses a drive circuit. The drive circuit includes a power MOSFET, and can cause the power MOSFET to perform a cutoff operation.

In some power supply systems mounted in vehicles, a low-voltage battery, a high-voltage battery, a power path to which power is supplied from the high-voltage battery, and a cutoff unit capable of cutting off the power path are mounted. For example, when the cutoff unit performs a cutoff operation using a drive circuit such as the one described in JP S62-21322A, there is concern that a surge voltage may be generated in the vicinity of the cutoff unit during the cutoff operation, and that a voltage due to the surge voltage may enter the low-voltage battery side. When the drive circuit is operated after detecting a short-circuit of the power path based on the value of a current flowing through the power path, there is also concern that a voltage due to the surge voltage may enter the low-voltage battery side via a short-circuit detection unit for detecting a short-circuit, or via the drive circuit.

An object of the present disclosure is to provide a technique with which a surge voltage generated due to a cutoff operation performed by a cutoff unit is easily prevented from entering into the low-voltage battery side.

### SUMMARY

An in-vehicle cutoff control device according to an aspect of the present disclosure is an in-vehicle cutoff control device for use in an in-vehicle system including: a low-voltage battery; a high voltage battery insulated from the low-voltage battery, and having an output voltage higher than an output voltage of the low-voltage battery; a power path to which power derived from the high voltage battery is supplied; a cutoff unit provided on the power path, and configured to be switched from a conductive state to allow a flow of current through the power path to a cutoff state to cut off the flow of current; and a current detection unit configured to output a detection signal configured to specify a value of a current flowing through the power path, the in-vehicle cutoff control device including: a conductive path insulated from the low-voltage battery, and to which a voltage lower than the output voltage of the high-voltage battery is applied; a voltage generation unit configured to generate a voltage to be applied to the conductive path, based on the output voltage of the low-voltage battery or the high voltage battery; a short-circuit detection unit configured to be driven by power received from the conductive path; and a drive unit configured to be operated by power received from the conductive path, and output a cutoff signal for switching the cutoff unit to the cutoff state, wherein the short-circuit detection unit receives input of the detection signal, and detects a short-circuit of the power path based on the detection signal, and the drive unit switches the cutoff unit to the cutoff state if the short-circuit detection unit has detected a short-circuit of the power path.

### Advantageous Effects

With a technique according to the present disclosure, a surge voltage resulting from a cutoff operation performed by a cutoff unit is easily prevented from entering the low-voltage battery side.

### BRIEF DESCRIPTION OF DRAWINGS

FIG. 1 is a block diagram schematically illustrating an in-vehicle system including an in-vehicle cutoff control device according to a first embodiment.

FIG. 2 is a block diagram schematically illustrating an in-vehicle system including an in-vehicle cutoff control device according to a second embodiment.

FIG. 3 is a block diagram schematically illustrating an in-vehicle system including an in-vehicle cutoff control device according to a third embodiment.

### DETAILED DESCRIPTION OF PREFERRED EMBODIMENTS

Embodiments of the present disclosure will be listed and illustrated below.

An in-vehicle cutoff control device for use in an in-vehicle system including: a low-voltage battery; a high-voltage battery insulated from the low-voltage battery, and having an output voltage higher than an output voltage of the low-voltage battery; a power path to which power derived from the high voltage battery is supplied; a cutoff unit provided on the power path, and configured to be switched from a conductive state to allow a flow of current through the power path to a cutoff state to cut off the flow of current; and a current detection unit configured to output a detection signal configured to specify a value of a current flowing through the power path, the in-vehicle cutoff control device including: a conductive path insulated from the low-voltage battery, and to which a voltage lower than the output voltage of the high voltage battery is applied; a voltage generation unit configured to generate a voltage to be applied to the conductive path, based on the output voltage of the low-voltage battery or the high voltage battery; a short-circuit detection unit configured to be driven by power received from the conductive path; and a drive unit configured to be operated by power received from the conductive path, and output a cutoff signal for switching the cutoff unit to the cutoff state, wherein the short-circuit detection unit receives input of the detection signal, and detects a short-circuit of the power path based on the detection signal, and the drive unit switches the cutoff unit to the cutoff state if the short-circuit detection unit has detected a short-circuit of the power path.

The in-vehicle cutoff control device according to the first aspect is used for an in-vehicle system having a configuration in which a low-voltage battery and a high voltage battery are insulated from each other. The above-described in-vehicle cutoff control device includes a short-circuit detection unit configured to detect a short-circuit of a power path to which power derived from the high voltage battery is supplied. Furthermore, the above-described in-vehicle cutoff control device includes a drive unit configured to switch the cutoff unit to the cutoff state if the short-circuit detection unit has detected a short-circuit of the power path. The short-circuit detection unit and the drive unit are driven by power received from the conductive path that is insulated from the low-voltage battery. Accordingly, with the above-described in-vehicle cutoff control device, a surge voltage generated due to the cutoff operation performed by the cutoff unit is easily prevented from entering the low-voltage battery side even if the surge voltage has entered the short-circuit detection unit or the drive unit.

In a second aspect, the in-vehicle cutoff control device according to the first aspect, wherein the voltage generation unit includes a transformer configured to insulate the low-voltage battery from the high voltage battery and the conductive path, step up a voltage derived from the low-voltage battery, and apply the voltage to the conductive path.

With the in-vehicle cutoff control device according to the second aspect, the insulation of the low-voltage battery from the high voltage battery and the conductive path can be increased by the transformer. Moreover, with the above-described in-vehicle cutoff control device, a voltage to be applied to the conductive path can be generated using the low-voltage battery.

In a third aspect, the in-vehicle cutoff control device according to the second aspect, wherein the transformer includes a first winding portion and a second winding portion that are insulated from each other, the voltage generation unit further includes a switching unit configured to be switched between an allowing state to allow a flow of current through the first winding portion from the low-voltage battery, and a cancelling state to cancel the allowing state, and a control unit configured to control the switching unit, the conductive path is electrically connected to the second winding portion, the cutoff unit includes a current input portion insulated from the power path, the drive unit includes a capacitor configured to receive power from the conductive path, and a switch provided between the conductive path and the current input portion, a charge current is supplied to the capacitor via the second winding portion and the conductive path in response to the switching unit being repeatedly switched between the allowing state and the cancelling state, and the capacitor is discharged in response to the switch being turned on, whereby a drive current flows through the current input portion.

The in-vehicle cutoff control device according to the third aspect can input, into the current input portion, a discharge current from the capacitor, instead of inputting, into the current input portion, only a current directly supplied from the second winding portion. Accordingly, the above-described in-vehicle cutoff control device can satisfy both a configuration including a transformer having a reduced size and a configuration capable of inputting a current of a certain magnitude into the current input portion, and it is therefore possible to easily reduce the size of a configuration capable of driving the cutoff unit, while increasing the insulation between the low-voltage battery and the high-voltage battery.

In a fourth aspect, the in-vehicle cutoff control device according to the first aspect, wherein the voltage generation unit includes a step-down unit configured to step down a voltage derived from the high voltage battery, and apply the voltage to the conductive path.

With the in-vehicle cutoff control device according to the fourth aspect, a voltage to be applied to the conductive path can be generated using the high-voltage battery.

In a fifth aspect, the in-vehicle cutoff control device according to any one of the first through the fourth aspects, wherein the cutoff unit includes a current input portion insulated from the power path, and is configured to be switched to the cutoff state in response to a drive current supplied from the drive unit flowing through the current input portion, and maintain the cutoff state even if the supply of the drive current is stopped after the cutoff unit has been changed to the cutoff state.

With the in-vehicle cutoff control device according to the fifth aspect, even if a voltage due to the surge voltage enters the drive unit after the cutoff unit has been switched to the cutoff state, and the drive unit has ceased to operate normally to stop the supply of the drive current from the drive unit, the cutoff state of the cutoff unit can be more reliably maintained.

In a sixth aspect, the in-vehicle cutoff control device according to the fifth aspect, wherein the cutoff unit is a pyrotechnic circuit breaker configured to cut off the power path if the drive current flows through the current input portion.

With the in-vehicle cutoff control device according to the sixth aspect, it is possible to supply a drive current to the current input portion, and cause the pyrotechnic circuit breaker to perform a cutoff operation. In the case of a pyrotechnic circuit breaker of this type, a surge voltage is likely to be generated in the vicinity of the pyrotechnic circuit breaker due to the cutoff operation. However, with the above-described in-vehicle cutoff control device, such a surge voltage is less likely to affect the low-voltage battery side.

In a seventh aspect, the in-vehicle cutoff control device according to any one of the first through the sixth aspects, further including: a voltage detection unit configured to detect a voltage of the power path; and a determination unit configured to output an abnormal signal if the voltage detected by the voltage detection unit has reached a predetermined abnormal value, wherein the determination unit is operated by power received from the conductive path.

With the in-vehicle cutoff control device according to the seventh aspect, a configuration for outputting an abnormal signal if the voltage of the power path has an abnormal value can be realized using the power supplied from the conductive path.

### FIRST EMBODIMENT

### Overview of In-Vehicle System 1

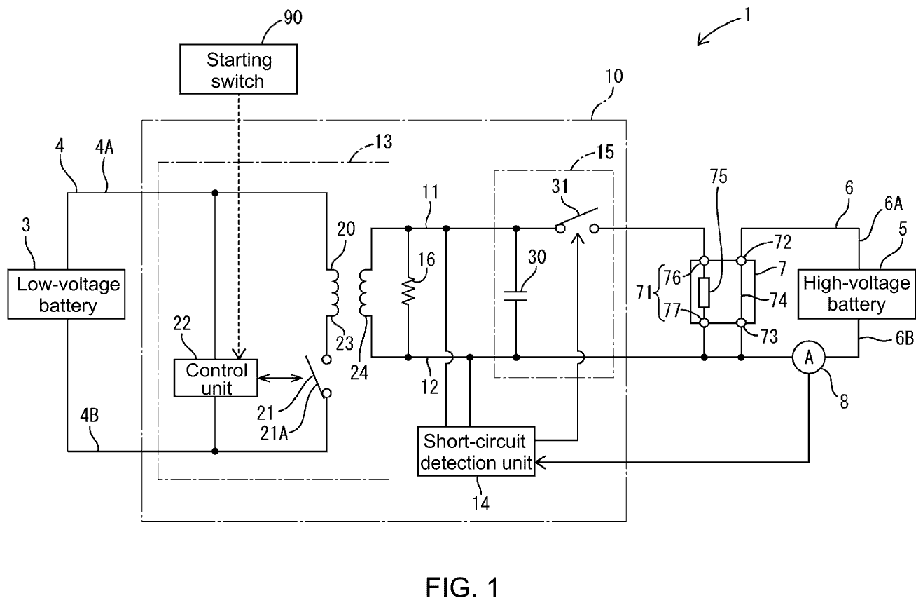

FIG. 1 shows an in-vehicle system 1 including an in-vehicle cutoff control device 10 according to a first embodiment. The in-vehicle system 1 is a system that is mounted in a vehicle, and can supply power to various loads. The vehicle in which the in-vehicle system 1 is mounted may be, for example, an electric automobile, a plug-in hybrid vehicle, a hybrid vehicle, or the like, or may be a vehicle of another type.

As shown in FIG. 1, the in-vehicle system 1 includes a low-voltage battery 3, a low-voltage side power path 4, a high voltage battery 5, a power path 6, a cutoff unit 7, a current detection unit 8, the in-vehicle cutoff control device 10, and a starting switch 90.

For example, when the vehicle is a plug-in hybrid vehicle or a hybrid vehicle, the starting switch 90 corresponds to an ignition switch configured to start an engine. When the vehicle is an electric automobile, the starting switch 90 corresponds to a power switch configured to start an EV system.

The low-voltage battery 3 is an in-vehicle power storage battery, and may be configured of a secondary battery such as a lead acid battery and a lithium ion battery, or may be configured of a power storage battery of another type. The low-voltage battery 3 applies a direct current voltage to the low-voltage side power path 4. The output voltage of the low-voltage battery 3 in a fully charged state is greater than 0 V, and is 12 V, for example.

The low-voltage side power path 4 is an electrical path through which power derived from the low-voltage battery 3 is transmitted. Although the use of the low-voltage side power path 4 is not limited, the low-voltage side power path 4 can be configured as, for example, an electrical path for supplying power to a power supply target (e.g., an Electronic Control Unit (ECU), a low-voltage load, or the like), which is not shown. The low-voltage side power path 4 includes a first low-voltage side power path 4A configured to be electrically connected to a positive electrode of the low-voltage battery 3, and a second low-voltage side power path 4B configured to be electrically connected to a negative electrode of the low-voltage battery 3. The output voltage of the low-voltage battery 3 is applied between the first low-voltage side power path 4A and the second low-voltage side power path 4B.

The high-voltage battery 5 is an in-vehicle power storage battery, and may be configured of a secondary battery such as a lithium ion battery, or may be configured of a power storage battery of another type. The high voltage battery 5 is insulated from the low-voltage battery 3. The high voltage battery 5 in a fully charged state applies a direct current voltage to the power path 6. The output voltage of the high voltage battery 5 in a fully charged state is greater than 0 V and greater than the output voltage of the low-voltage battery 3 in a fully charged state, and is 400 V, for example.

The power path 6 is an electrical path through which power derived from the high voltage battery 5 is transmitted. Although the use of the power path 6 is not limited, the power path 6 can be configured as, for example, an electrical path for supplying power to an in-vehicle high voltage load (e.g., an inverter or the like). The power path 6 includes a first power path 6A and a second power path 6B. One end of the first power path 6A is electrically connected to a positive electrode of the high voltage battery 5, and the other end thereof is electrically connected to one side of the cutoff unit 7. One end of the second power path 6B is electrically connected to a negative electrode of the high voltage battery 5, and the other end thereof is electrically connected to the other side of the cutoff unit 7. The second power path 6B is electrically connected to the ground. The output voltage of the high-voltage battery 5 is applied between the first power path 6A and the second power path 6B. A voltage that is higher than the voltage applied to the low-voltage side power path 4 is applied to the power path 6. The first power path 6A and the second power path 6B are short-circuited to each other when the cutoff unit 7 is in a conductive state, and are insulated from each other when the cutoff unit 7 is a cutoff state.

In the example of FIG. 1, the cutoff unit 7 is provided on the power path 6, and performs a cutoff operation in which a conductive state to allow a flow of current through the power path 6 is switched to a cutoff state to cut off the flow of current. The cutoff unit 7 includes a current input portion 71, conductor portions 72, 73, and 74, an ignitor 75, and a displacement portion (not shown). The cutoff unit 7 is, for example, a pyrotechnic circuit breaker that cuts off the power path 6 when a drive current flows through the current input portion 71. As the pyrotechnic circuit breaker, an explosive fuse such as a known pyrofuse (registered trademark) can be suitably used.

The current input portion 71 includes a first terminal portion 76 and a second terminal portion 77. The current input portion 71 is a portion through which a current flowing from the first terminal portion 76 toward the second terminal portion 77 flows when a drive unit 15 described below outputs a cutoff signal (more specifically, when the drive unit 15 described below supplies a drive current). The current input portion 71 is insulated from the power path 6.

The conductor portion 72 is a terminal that is connected to the first power path 6A and is short-circuited to the first power path 6A. The conductor portion 73 is a terminal that is connected to the second power path 6B and is short-circuited to the second power path 6B. The conductor portion 74 is a conductor configured to short-circuit the conductor portion 72 and the conductor portion 73.

The ignitor 75 is a portion that functions so as to cause a small-scale explosion when a current flows from the first terminal portion 76 toward the second terminal portion 77, and to move the displacement portion by this explosion. The displacement portion is held at a predetermined position before an explosion occurs in the ignitor 75 (when the conductor portions 72, 73, and 74 are short-circuited to each other). When an explosion occurs in the ignitor 75, the displacement portion is displaced to the conductor portion 74 side by the explosion, and functions so as to disconnect and cut off the conductor portion 74.

The cutoff unit 7 is operated to cut off the power path 6 when a drive current supplied from the drive unit 15 described below flows through the current input portion 71 (specifically, when the current flows from the first terminal portion 76 to the second terminal portion 77 via the ignitor 75). That is, the cutoff unit 7 is switched from the conductive state to the cutoff state when a drive current flows through the current input portion 71. After being switched to the cutoff state, the cutoff unit 7 maintains the cutoff state even if the supply of the drive current is stopped.

The current detection unit 8 is configured as a known current sensor, for example. The current detection unit 8 detects the value of a current flowing through the power path 6, and outputs a detection signal configured to specify the detected current value.

### Configuration of In-Vehicle Cutoff Control Device 10

The in-vehicle cutoff control device 10 is a device used for the in-vehicle system 1. The in-vehicle cutoff control device 10 includes a first conductive path 11, a second conductive path 12, a voltage generation unit 13, a short-circuit detection unit 14, a drive unit 15, and a resistor unit 16.

The voltage generation unit 13 generates a voltage to be applied to the first conductive path 11, based on the output voltage of the low-voltage battery 3. The voltage generation unit 13 includes a transformer 20, a switching unit 21, and a control unit 22.

The transformer 20 insulates the low-voltage battery 3 and the high-voltage battery 5 from each other, and insulates the low-voltage battery 3 and the first conductive path 11 from each other. The transformer 20 steps up a voltage derived from the low-voltage battery 3, and applies the voltage to the first conductive path 11. The transformer 20 includes a first winding portion 23 and a second winding portion 24. The first winding portion 23 and the second winding portion 24 are insulated from each other. Each of the first winding portion 23 and the second winding portion 24 is configured as a coil. When a change in current occurs in the first winding portion 23, the transformer 20 causes the second winding portion 24 to generate a voltage corresponding to the change in current of the first winding portion 23.

The switching unit 21 is provided on the low-voltage side power path 4. The switching unit 21 is provided between the low-voltage battery 3 and the first winding portion 23. The switching unit 21 is switched between an allowing state to allow a flow of current through the first winding portion 23 from the low-voltage battery 3, and a cancelling state to cancel the allowing state. The switching unit 21 includes a switching switch 21A. As a result of the switching switch 21A entering an ON state, the switching unit 21 enters the allowing state to allow a flow of current through the first winding portion 23 from the low-voltage battery 3. As a result of the switching switch 21A entering an OFF state, the switching unit 21 enters the cancelling state to cancel the allowing state. The switching switch 21A is configured of, for example, a switching element, and more specifically, a semiconductor switch element such as a Field Effect Transistor (FET). Note that the switching switch 21A may be a switching element (e.g., a bipolar transistor or the like) other than FETs.

The control unit 22 includes a control device. The control device is an information processing device having calculation functionality and information processing functionality, and includes, for example, a CPU and a storage unit. The control unit 22 outputs an ON signal for turning on the switching switch 21A, and an OFF signal for turning off the switching switch 21A. One of the ON signal and the OFF signal is a high-level signal, for example, and the other is a low-level signal, for example.

The switching switch 21A is turned on when the ON signal is being applied thereto from the control unit 22. Thus, the switching unit 21 is switched to the allowing state. The switching switch 21A is turned off when the OFF signal is being applied thereto from the control unit 22. Thus, the switching unit 21 is switched to the cancelling state.

An input voltage Vin that is equivalent to the output voltage of the low-voltage battery 3 is applied across the first winding portion 23 when the switching unit 21 is in the allowing state. When an output voltage Vout represents the voltage across the second winding portion 24, Vin/Vout=N1/N2 is satisfied. That is, in response to the switching switch 21A being switched from the cancelling state to the allowing state, an output voltage satisfying Vout=Vin×N2/N1 is generated in the second winding portion 24. In the present embodiment, a number of turns N1 of the first winding portion 23 is smaller than a number of turns N2 of the second winding portion 24. Accordingly, a voltage obtained by stepping up the output voltage of the low-voltage battery 3 is generated in the second winding portion 24. The voltage generated in the second winding portion 24 is applied to the first conductive path 11.

In this manner, the voltage generation unit 13 steps up a voltage derived from the low-voltage battery 3, and applies the voltage to the first conductive path 11.

The first conductive path 11 corresponds to an example of a “conductive path”. The first conductive path 11 is insulated from the low-voltage battery 3. The first conductive path 11 is electrically connected to the second winding portion 24, and a voltage generated by the voltage generation unit 13 is applied to the first conductive path 11. A voltage that is lower than the output voltage of the high-voltage battery 5 is applied to the first conductive path 11. The first conductive path 11 is an electrical path provided between one end of the second winding portion 24 and the drive unit 15. The second conductive path 12 is an electrical path provided between the other end of the second winding portion 24 and the drive unit 15. The second conductive path 12 is electrically connected to the ground. The second conductive path 12 is electrically connected to the second power path 6B via the ground, and short-circuits the second power path 6B.

The short-circuit detection unit 14 is provided between the first conductive path 11 and the second conductive path 12, and is connected to the first conductive path 11 and the second conductive path 12. The short-circuit detection unit 14 is driven by power received from the first conductive path 11. A detection signal that is output from the current detection unit 8 is input into the short-circuit detection unit 14. The short-circuit detection unit 14 detects a short-circuit of the power path 6 based on the detection signal. For example, the short-circuit detection unit 14 determines, based on the detection signal, whether the value of a current flowing through the power path 6 exceeds a threshold current, and determines that the power path 6 has short-circuited if the value exceeds the threshold current. The short-circuit detection unit 14 outputs a non-short-circuit signal (OFF signal) in a stage before a short-circuit of the power path 6 is detected, and outputs a short-circuit signal (ON signal) if a short-circuit of the power path 6 has been detected.

The drive unit 15 is provided between the first conductive path 11 and the second conductive path 12, and is connected to the first conductive path 11 and the second conductive path 12. The drive unit 15 is operated by power received from the first conductive path 11, and outputs a cutoff signal for switching the cutoff unit 7 to the cutoff state. The drive unit 15 switches the cutoff unit 7 to the cutoff state if the short-circuit detection unit 14 has detected a short-circuit of the power path 6. The drive unit 15 includes a capacitor 30 and a switch 31.

The capacitor 30 is an element that is electrically connected to the first conductive path 11 and the second conductive path 12, and that receives power from the first conductive path 11. One electrode of the capacitor 30 is electrically connected to the first conductive path 11, and the other electrode thereof is electrically connected to the second conductive path 12. The capacitor 30 is charged by power received from the first conductive path 11.

The switch 31 is provided between the first conductive path 11 and the current input portion 71. The switch 31 is configured of a semiconductor switch such as a Field Effect Transistor (FET), or a mechanical relay or the like. The switch 31 allows a flow of current from the capacitor 30 side to the first terminal portion 76 side when the switch 31 is in the ON state, and cuts off a flow of current from the capacitor 30 side to the first terminal portion 76 side when the switch 31 is in the OFF state. Specifically, the switch 31 is in the ON state when the short-circuit detection unit 14 is outputting a short-circuit signal (ON signal), and is in the OFF state when the short-circuit detection unit 14 is outputting a non-short-circuit signal (OFF signal). Also, the current conduction via the switch 31 is cut off in both directions when the switch 31 is in the OFF state, and the current conduction via the switch 31 is allowed in both directions when the switch 31 is in the ON state.

In this manner, the drive unit 15 turns the switch 31 to the ON state when a non-short-circuit signal is being input from the short-circuit detection unit 14, thus cutting of a flow of current from the capacitor 30 side to the first terminal portion 76 side. When a short-circuit signal is input from the short-circuit detection unit 14, the drive unit 15 outputs a cutoff signal for switching the cutoff unit 7 to the cutoff state. Specifically, the drive unit 15 switches the switch 31 to the ON state when a short-circuit signal is input from the short circuit detection unit 14. The capacitor 30 is discharged in response to the operation of the switch 31, whereby a drive current flows through the current input portion 71. That is, if the short-circuit detection unit 14 has detected a short-circuit of the power path 6, the drive unit 15 supplies a drive current to the current input portion 71, and switches the cutoff unit 7 to the cutoff state.

The resistor unit 16 has a function of discharging the capacitor 30. The resistor unit 16 is connected in parallel with the capacitor 30 between the first conductive path 11 and the second conductive path 12, and is connected in parallel with the cutoff unit 7.

### Operations of In-Vehicle Cutoff Control Device 10

The voltage generation unit 13 performs a generation operation of generating a voltage to be applied to the first conductive path 11, based on the output voltage of the low-voltage battery 3. During a period in which the generation operation is performed, the control unit 22 applies, to the switching switch 21A, an ON/OFF signal in which an ON signal and an OFF signal are alternately repeated, thus turning the switching switch 21A on and off. In response to the switching switch 21A being switched from the OFF state to the ON state, the input voltage Vin corresponding to the output voltage of the low-voltage battery 3 is applied across the first winding portion 23. In response to the switching switch 21A being switched from the ON state to the OFF state, the application of the voltage across the first winding portion 23 from the low-voltage battery 3 is cancelled. Through the ON/OFF operation, a state in which an output voltage V1 is applied across the first winding portion 23, and a state in which the application of the output voltage V1 across the first winding portion 23 is cancelled are alternately switched. In response to the ON/OFF operation, an output voltage of up to about V1×N2/N1 is generated in the second winding portion 24. In response to the switching unit 21 being repeatedly switched between the allowing state and the cancelling state alternately in this manner, power is supplied from the second winding portion 24 side to the first conductive path 11, and the power is supplied to the short-circuit detection unit 14 and the drive unit 15 via the first conductive path 11. That is, a charge current is supplied to the capacitor 30. In this state, a slight current may flow through the resistor unit 16.

The voltage generation unit 13 may start the above-described generation operation in response to the starting switch 90 configured to start the vehicle being switched from an OFF state to an ON state. When the starting switch 90 is in the ON state, the voltage generation unit 13 may continue the generation operation until the starting switch 90 enters the OFF state. When the starting switch 90 is switched from the ON state to the OFF state, the voltage generation unit 13 may stop the generation operation. In this example, when the starting switch 90 is maintained in the OFF state after being switched from the ON state to the OFF state, the switching unit 21 maintains the cancelling state. Accordingly, if the switch 31 is in the OFF state, the capacitor 30 is discharged by the resistor unit 16 while the passage of current from the capacitor 30 to the current input portion 71 is cut off. On the other hand, when the starting switch 90 is maintained in the ON state after being switched from the OFF state to the ON state, the voltage generation unit 13 performs the generation operation. Accordingly, if the switch 31 is in the OFF state, a current flows through the resistor unit 16 while a charge current is supplied to the capacitor 30 from the second winding portion 24 side.

The short-circuit detection unit 14 detects a short-circuit of the power path 6, based on a detection signal configured to specify the value of a current flowing through the power path 6. The short-circuit detection unit 14 outputs a short-circuit signal if a short-circuit of the power path 6 has been detected. If the short-circuit signal has been input, the drive unit 15 switches the switch 31 to the ON state. If the switch 31 is switched from the OFF state to the ON state while the capacitor 30 is being charged, the capacitor 30 is discharged in response to the switch 31 being turned on, whereby a drive current flows through the current input portion 71. If a drive current is supplied to the current input portion 71 from the capacitor 30, a small-scale explosion occurs in the ignitor 75, and the cutoff unit 7 cuts off the power path 6. After being switched to the cutoff state, the cutoff unit 7 maintains the cutoff state even if the supply of the drive current is stopped.

In the present embodiment, the maximum value of the drive current supplied to the current input portion 71 in response to the switch 31 being turned on is preferably greater than the maximum value of the charge current supplied to the capacitor 30 during charging of the capacitor 30. The control unit 22 applies a PWM signal to the switching switch 21A while adjusting the duty so as to satisfy such a relationship.

### Examples of Effects

The in-vehicle cutoff control device 10 is used for the in-vehicle system 1 having a configuration in which a low-voltage battery 3 and a high voltage battery 5 are insulated from each other. The in-vehicle cutoff control device 10 includes a short-circuit detection unit 14 configured to detect a short-circuit of a power path 6 through which power derived from the high-voltage battery 5 is supplied. Furthermore, the in-vehicle cutoff control device 10 includes a drive unit 15 configured to switch a cutoff unit 7 to a cutoff state if the short-circuit detection unit 14 has detected a short-circuit of the power path 6. The short-circuit detection unit 14 and the drive unit 15 are driven by power received from a first conductive path 11 that is insulated from the low-voltage battery 3. Accordingly, with the in-vehicle cutoff control device 10, a surge voltage generated due to a cutoff operation performed by the cutoff unit 7 is easily prevented from entering the low-voltage battery 3 side even if the surge voltage has entered the short-circuit detection unit 14 and the drive unit 15.

Furthermore, the voltage generation unit 13 includes a transformer 20 configured to insulate the low-voltage battery 3 from the high voltage battery 5 and the first conductive path 11, step up a voltage derived from the low-voltage battery 3, and apply the voltage to the first conductive path 11. With this configuration, the insulation of the low-voltage battery 3 from the high voltage battery 5 and the first conductive path 11 can be increased by the transformer 20. Moreover, with this configuration, a voltage to be applied to the first conductive path 11 can be generated using the low-voltage battery 3.

Furthermore, the in-vehicle cutoff control device 10 can input, into the current input portion 71, a discharge current from the capacitor 30, instead of inputting, into the current input portion 71, only a current directly supplied from the second winding portion 24. Accordingly, the in-vehicle cutoff control device 10 can satisfy both a configuration including a transformer 20 having a reduced size and a configuration capable of inputting a current of a certain magnitude into the current input portion 71, and it is therefore possible to easily reduce the size of a configuration capable of driving the cutoff unit 7, while increasing the insulation between the low-voltage battery 3 and the high voltage battery 5.

Furthermore, the cutoff unit 7 is switched to the cutoff state in response to the drive current supplied from the drive unit 15 flowing through the current input portion 71, and maintains the cutoff state even if the supply of the drive current is stopped after the cutoff unit 7 has been switched to the cutoff state. With this configuration, even if a voltage due to the surge voltage enters the drive unit 15 after the cutoff unit 7 has been switched to the cutoff state, and the drive unit 15 has ceased to operate normally to stop the supply of the drive current from the drive unit 15, the cutoff state of the cutoff unit 7 can be more reliably maintained.

Furthermore, the cutoff unit 7 is a pyrotechnic circuit breaker configured to cut off the power path 6 when a drive current flows through the current input portion 71. With this configuration, it is possible to supply a drive current to the current input portion 71, and cause the pyrotechnic circuit breaker to perform a cutoff operation. In the case of a pyrotechnic circuit breaker of this type, a surge voltage is likely to be generated in the vicinity of the pyrotechnic circuit breaker due to the cutoff operation. However, with the in-vehicle cutoff control device 10, such a surge voltage is less likely affect the low-voltage battery 3 side.

### SECOND EMBODIMENT

Although the voltage generation unit in the first embodiment is configured to step up a voltage derived from the low-voltage battery 3, and apply the voltage to the first conductive path 11, the present disclosure is not limited to this configuration. In the second embodiment, an example will be described in which the voltage generation unit is configured to step down a voltage derived from the high voltage battery 5, and apply the voltage to the first conductive path 11. In the description of the second embodiment, the same components as those of the first embodiment are denoted by the same reference numerals, and the detailed description thereof has been omitted.

### Configuration of In-Vehicle System 201

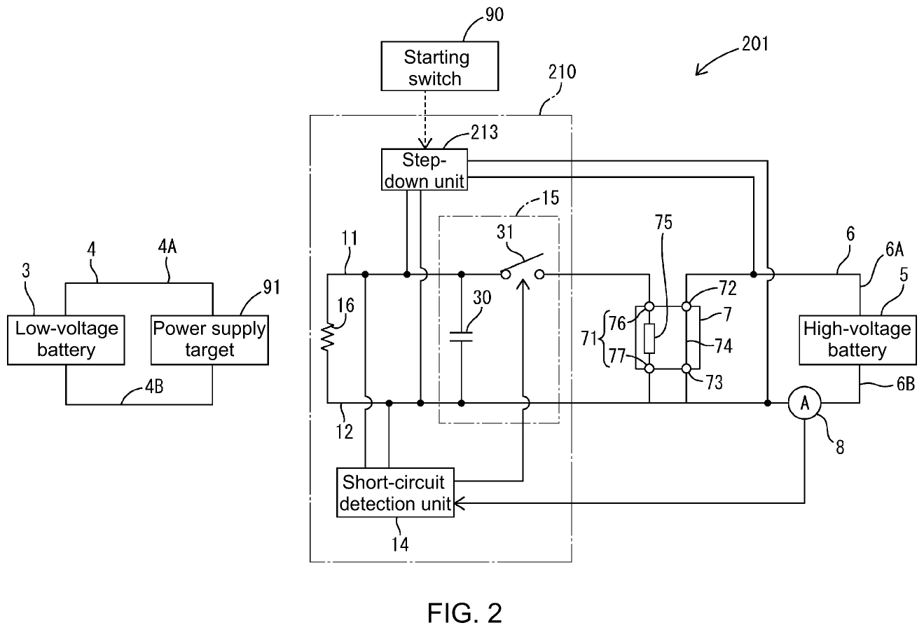

FIG. 2 shows an in-vehicle system 201 including an in-vehicle cutoff control device 210 according to a second embodiment. The in-vehicle system 201 is a system that is mounted in a vehicle, and can supply power to various loads. The vehicle in which the in-vehicle system 201 is mounted may be, for example, an electric automobile, a plug-in hybrid vehicle, a hybrid vehicle, or the like, or may be a vehicle of another type.

As shown in FIG. 2, the in-vehicle system 201 includes a low-voltage battery 3, a low-voltage side power path 4, a high-voltage battery 5, a power path 6, a cutoff unit 7, a current detection unit 8, the in-vehicle cutoff control device 210, a starting switch 90, and a power supply target 91.

The power supply target 91 is, for example, an Electronic Control Unit (ECU), a low-voltage load, or the like. The power supply target 91 is provided between a first low-voltage side power path 4A and a second low-voltage side power path 4B. Power derived from the low-voltage battery 3 is supplied to the power supply target 91 via the low-voltage side power path 4.

The in-vehicle cutoff control device 210 is a device used for the in-vehicle system 201. The in-vehicle cutoff control device 210 includes a first conductive path 11, a second conductive path 12, a step-down unit 213, a short-circuit detection unit 14, a drive unit 15, and a resistor unit 16.

The step-down unit 213 corresponds to an example of a “voltage generation unit”. The step-down unit 213 is configured as a step-down regulator, for example. The step-down unit 213 performs a generation operation of stepping down a voltage derived from the high voltage battery 5, and applying the voltage to the first conductive path 11. The step-down unit 213 is connected to the first power path 6A, the second power path 6B, the first conductive path 11, and the second conductive path 12. The step-down unit 213 steps down a voltage between the first power path 6A and the second power path 6B, and applies the voltage between the first conductive path 11 and the second conductive path 12.

### Operations of In-Vehicle Cutoff Control Device 210

The step-down unit 213 performs the above-described generation operation. The 1 step-down unit 213 may start the above-described generation operation in response to the starting switch 90 configured to start the vehicle being switched from an OFF state to an ON state. When the starting switch 90 is in the ON state, the step-down unit 213 may continue the generation operation until the starting switch 90 enters the OFF state. When the starting switch 90 is switched from the ON state to the OFF state, the step-down unit 213 may stop the generation operation. In this example, when the starting switch 90 is maintained in the OFF state after being switched from the ON state to the OFF state, the capacitor 30 is discharged by the resistor unit 16 while the passage of current from the capacitor 30 to the current input portion 71 is cut off, if the switch 31 is in the OFF state. On the other hand, when the starting switch 90 is maintained in the ON state after being switched from the OFF state to the ON state, the step-down unit 213 performs the generation operation. Accordingly, if the switch 31 is in the OFF state, a current flows through the resistor unit 16 while a charge current is supplied to the capacitor 30 from the second winding portion 24 side.

The short-circuit detection unit 14 detects a short-circuit of the power path 6, based on a detection signal configured to specify the value of a current flowing through the power path 6. The short-circuit detection unit 14 outputs a short-circuit signal if a short-circuit of the power path 6 has been detected. The drive unit 15 switches the switch 31 to the ON state if a short-circuit signal has been input. If the switch 31 is switched from the OFF state to the ON state while the capacitor 30 is being charged, the capacitor 30 is discharged in response to the switch 31 being turned on, whereby a drive current flows through the current input portion 71. If a drive current is supplied to the current input portion 71 from the capacitor 30, a small-scale explosion occurs in the ignitor 75, and the cutoff unit 7 cuts off the power path 6. After being switched to the cutoff state, the cutoff unit 7 maintains the cutoff state even if the supply of the drive current is stopped.

### Examples of Effects

With the in-vehicle cutoff control device 210, a voltage to be applied to the first conductive path 11 can be generated using the high voltage battery 5. Moreover, with the in-vehicle cutoff control device 210, the low-voltage battery 3 side and the high-voltage battery 5 side can be configured as separate circuits.

Accordingly, the low-voltage battery 3 side and the high voltage battery 5 side can be insulated from each other without providing any member for insulation.

### THIRD EMBODIMENT

The first embodiment or the second embodiment may be additionally provided with a configuration in which whether the voltage of the high-voltage battery 5 has an abnormal value is monitored using the power supplied from the first conductive path 11. The third embodiment is based on the configuration of the first embodiment, and describes an example in which a configuration in which whether the voltage of the high voltage battery 5 has an abnormal value is monitored using the power supplied from the first conductive path 11 is additionally provided. In the description of the third embodiment, the same components as those of the first embodiment are denoted by the same reference numerals, and the detailed description thereof has been omitted.

### Configuration of In-Vehicle System 301

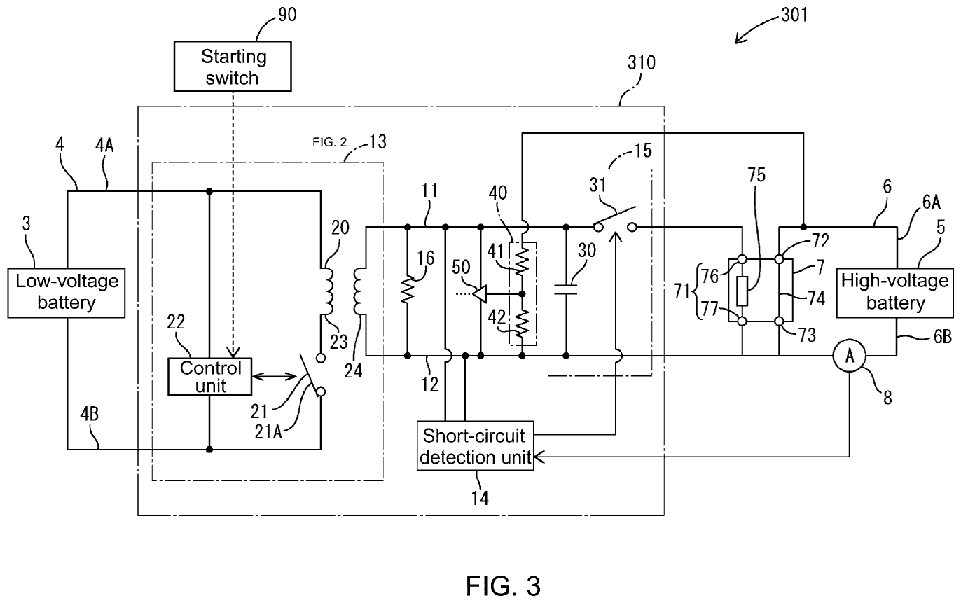

FIG. 3 shows an in-vehicle system 301 including an in-vehicle cutoff control device 310 according to the third embodiment. The in-vehicle system 301 is a system that is mounted in a vehicle, and can supply power to various loads. The vehicle in which the in-vehicle system 301 is mounted may be, for example, an electric automobile, a plug-in hybrid vehicle, a hybrid vehicle, or the like, or may be a vehicle of another type.

As shown in FIG. 3, the in-vehicle system 301 includes a low-voltage battery 3, a low-voltage side power path 4, a high voltage battery 5, a power path 6, a cutoff unit 7, a current detection unit 8, the in-vehicle cutoff control device 310, and a starting switch 90.

The in-vehicle cutoff control device 310 is a device used for the in-vehicle system 301. The in-vehicle cutoff control device 310 includes a first conductive path 11, a second conductive path 12, a voltage generation unit 13, a short-circuit detection unit 14, a drive unit 15, a resistor unit 16, a voltage detection unit 40, and a determination unit 50.

The voltage detection unit 40 detects the voltage of the power path 6 (more specifically, the voltage between a first power path 6A and a second power path 6B). The voltage detection unit 40 is configured as, for example, a known voltage detection circuit (more specifically, a voltage divider circuit). The voltage detection unit 40 includes a first voltage-dividing resistor 41 and a second voltage-dividing resistor 42. One end of the first voltage-dividing resistor 41 is electrically connected to the power path 6 (specifically, the first power path 6A). The other end of the first voltage-dividing resistor 41 is connected to one end of the second voltage-dividing resistor 42. The other end of the second voltage-dividing resistor 42 is connected to the second conductive path 12. The voltage detection unit 40 outputs a voltage signal configured to specify the voltage of the power path 6. Specifically, the voltage detection unit 40 outputs a voltage obtained by dividing the voltage of the power path 6 by the first voltage-dividing resistor 41 and the second voltage-dividing resistor 42.

The determination unit 50 outputs an abnormal signal if the voltage detected by the voltage detection unit 40 has reached a predetermined abnormal value. The abnormal value may be a fixed value, or may be a value that is set according to the SOC or the like of the high-voltage battery 5. The determination unit 50 is electrically connected to the first conductive path 11 and the second conductive path 12, and is operated by power received from the first conductive path 11. The determination unit 50 is configured as a comparator, for example. A voltage signal configured to specify the voltage of the power path 6 is input into the determination unit 50. The determination unit 50 determines, based on the voltage signal, whether the voltage of the power path 6 has an abnormal value. The determination unit 50 outputs an abnormal signal if it is determined that the voltage of the power path 6 has an abnormal value. This enables the in-vehicle cutoff control device 310 to inform a device external to the in-vehicle cutoff control device 310 that the voltage of the power path 6 is abnormal.

### Examples of Effects

With the in-vehicle cutoff control device 310, a configuration for outputting an abnormal signal if the voltage of the power path 6 has an abnormal value can be realized using the power supplied from the first conductive path 11.

### OTHER EMBODIMENTS

The present disclosure is not limited to the embodiments described by the above statements and drawings. For example, any combinations of the features of the embodiments described above and below are possible as long as there are no mutual inconsistencies. Also, any features of the embodiments described above and below may be omitted unless explicitly described as essential. Furthermore, the above-described embodiments may be modified as follows.

Each of the above embodiments includes a configuration in which the cutoff unit and the current detection unit are not included in the in-vehicle cutoff control device. However, it is also possible to adopt a configuration in which part or the whole of the cutoff unit and the current detection unit is included in the in-vehicle cutoff control device.

It should be understood that the embodiment disclosed herein is in all respects illustrative and not restrictive. The scope of the present disclosure is not limited to the embodiments disclosed herein, and is intended to include all modifications which fall within the scope defined by the claims, and the meaning and scope of equivalents thereof.

1. An in-vehicle cutoff control device for use in an in-vehicle system including:
a low-voltage battery;
a high-voltage battery insulated from the low-voltage battery, and having an output voltage higher than an output voltage of the low-voltage battery;
a power path to which power derived from the high-voltage battery is supplied;
a cutoff unit provided on the power path, and configured to be switched from a conductive state to allow a flow of current through the power path to a cutoff state to cut off the flow of current; and
a current detection unit configured to output a detection signal configured to specify a value of a current flowing through the power path,
the in-vehicle cutoff control device comprising:
a conductive path insulated from the low-voltage battery, and to which a voltage lower than the output voltage of the high-voltage battery is applied;
a voltage generation unit configured to generate a voltage to be applied to the conductive path, based on the output voltage of the low-voltage battery or the high-voltage battery;
a short-circuit detection unit configured to be driven by power received from the conductive path; and
a drive unit configured to be operated by power received from the conductive path, and output a cutoff signal for switching the cutoff unit to the cutoff state, wherein the short-circuit detection unit receives input of the detection signal, and detects a short-circuit of the power path based on the detection signal, and
the drive unit switches the cutoff unit to the cutoff state if the short-circuit detection unit has detected a short-circuit of the power path.

2. The in-vehicle cutoff control device according to claim 1, wherein
the voltage generation unit includes a transformer configured to insulate the low-voltage battery from the high-voltage battery and the conductive path, step up a voltage derived from the low-voltage battery, and apply the voltage to the conductive path.

3. The in-vehicle cutoff control device according to claim 2, wherein
the transformer includes a first winding portion and a second winding portion that are insulated from each other,
the voltage generation unit further includes a switching unit configured to be switched between an allowing state to allow a flow of current through the first winding portion from the low-voltage battery, and a cancelling state to cancel the allowing state, and a control unit configured to control the switching unit,
the conductive path is electrically connected to the second winding portion,
the cutoff unit includes a current input portion insulated from the power path,
the drive unit includes a capacitor configured to receive power from the conductive path, and a switch provided between the conductive path and the current input portion,
a charge current is supplied to the capacitor via the second winding portion and the conductive path in response to the switching unit being repeatedly switched between the allowing state and the cancelling state, and
the capacitor is discharged in response to the switch being turned on, whereby a drive current flows through the current input portion.

4. The in-vehicle cutoff control device according to claim 1, wherein
the voltage generation unit includes a step-down unit configured to step down a voltage derived from the high-voltage battery, and apply the voltage to the conductive path.

5. The in-vehicle cutoff control device according to claim 1, wherein
the cutoff unit includes a current input portion insulated from the power path, and is configured to be switched to the cutoff state in response to a drive current supplied from the drive unit flowing through the current input portion, and maintain the cutoff state even if the supply of the drive current is stopped after the cutoff unit has been changed to the cutoff state.

6. The in-vehicle cutoff control device according to claim 5, wherein
the cutoff unit is a pyrotechnic circuit breaker configured to cut off the power path if the drive current flows through the current input portion.

7. The in-vehicle cutoff control device according to claim 1, further comprising:
a voltage detection unit configured to detect a voltage of the power path; and
a determination unit configured to output an abnormal signal if the voltage detected by the voltage detection unit has reached a predetermined abnormal value, wherein
the determination unit is operated by power received from the conductive path.

8. The in-vehicle cutoff control device according to claim 2, wherein
the cutoff unit includes a current input portion insulated from the power path, and is configured to be switched to the cutoff state in response to a drive current supplied from the drive unit flowing through the current input portion, and maintain the cutoff state even if the supply of the drive current is stopped after the cutoff unit has been changed to the cutoff state.

9. The in-vehicle cutoff control device according to claim 2, further comprising:
a voltage detection unit configured to detect a voltage of the power path; and
a determination unit configured to output an abnormal signal if the voltage detected by the voltage detection unit has reached a predetermined abnormal value, wherein
the determination unit is operated by power received from the conductive path.
